(19) United States
(12) Patent Application Publication
(10) Pub. No.: US 2021/0286424 A1
(43) Pub. Date: Sep. 16, 2021

(54) YOUTH SIMULATOR METHODS AND SYSTEM

(71) Applicant: Alexandra Ivanovitch, Miami Beach, FL (US)

(72) Inventor: Alexandra Ivanovitch, Miami Beach, FL (US)

(21) Appl. No.: 17/198,852

(22) Filed: Mar. 11, 2021

Related U.S. Application Data
(60) Provisional application No. 62/988,597, filed on Mar. 12, 2020.

(51) Int. Cl. G06F 3/01; G06T 19/00

(52) U.S. Cl. CPC G06F 3/011; G06T 19/00

(57) ABSTRACT

A youth simulator system may include: a virtual reality interface; an appearance engine configured to use a digital photograph depicting a user to form a young digital avatar of the user; an environmental engine configured to generate various virtual reality environments and activity scenarios that the user may interact with during virtual reality sessions that reinforce the simulation of youth to the user; and a simulation engine configured to generate the actions and interactions of the young digital avatar of the user in and with virtual reality environments and activity scenarios provided by an environmental engine, and configured to map the movements of the user, using data recorded by a virtual reality interface, onto a young digital avatar of the user so that the movements of the young digital avatar of the user are synchronized with the actual physical movements of the user.

### CROSS REFERENCE TO RELATED APPLICATIONS

This application claims priority to and the benefit of the filing date of U.S. Provisional Application No. 62/988,597, filed on Mar. 12, 2020, entitled “YOUTH SIMULATOR METHOD AND SYSTEM”, which is hereby incorporated by reference in its entirety.

### FIELD OF THE INVENTION

This patent specification relates to the field of virtual reality. More specifically, this patent specification relates to systems and methods that use virtual reality to transform a user's perception and behavior via youth simulation.

### BACKGROUND

Globally, the world is facing a major demographic shift. Approximately, 8.5% of people worldwide (617 million) are aged 65 and over. By 2050, this percentage is projected to more than double, reaching 1.6 billion. The global population of the “oldest old”—people aged 80 and older—is expected to more than triple between 2015 and 2050, growing from 126 million to 447 million. Unfortunately, this will cause the number of people experiencing age-related health issues (potentially on a multitude of levels: mental, physical, behavioral, cognitive) to also increase proportionately. At the current pace, population aging is poised to impose a significant strain on economies, health systems, and social structures worldwide.

Therefore, a need exists for novel systems and methods for addressing age-related health issues which may be experienced by an individual. A further need exists for novel systems and methods for increasing the quality of life for individuals experiencing age-related health issues. Yet another need exists for novel systems and methods of ameliorating age-related health issues which are not invasive or physically burdensome to elderly individuals.

### BRIEF SUMMARY OF THE INVENTION

A youth simulator system and method is provided which is configured to enable users, such as older adults, to connect to computer generated environments as avatars of their younger selves and perform a series of activities which will encourage mental and social stimulation in a holistic and systems approach to mental and behavioral health for aging populations in extended periods of longevity. In this manner, the system and method provide immersive virtual reality which allows users to experience sensations of ownership over a more youthful looking virtual body inside an immersive virtual environment, which in turn allows virtual reality users to have the feeling of being “embodied” in a more youthful looking virtual body for many purposes, such as to extend their healthy lifespan, and more specifically to ameliorate quality of life and subjective sense of well-being, as well as for experimental and clinical pain and symptom relief and prevention.

According to one embodiment consistent with the principles of the invention, a youth simulator system is provided which may include: a virtual reality interface having a display interface and a controller interface; an appearance engine configured to use or combine one or more digital photographs depicting a user into a youthful digital 3D model for the user's face and/or body that may be used to form a young digital avatar of the user; an environmental engine configured to generate digital 3D models for various virtual reality environments and activity scenarios that the user may interact with via the virtual reality interface during virtual reality sessions that are designed to reinforce the simulation of youth to the user; and a simulation engine, in which the simulation engine is configured to use data describing the youthful digital 3D model for the user's face and/or body to form the young digital avatar of the user and to generate the actions and interactions of the young digital avatar of the user in and with virtual reality environments and activity scenarios provided by an environmental engine, and in which the simulation engine is configured to map the movements of the user, using data recorded by a virtual reality interface, onto a young digital avatar of the user so that the movements of the young digital avatar of the user match the actual physical movements of the user.

According to another embodiment consistent with the principles of the invention, a youth simulator method is provided which may include the steps of: receiving digital photographs of user depicting user as being younger looking in appearance; generating a 3D model for the user's face and/or body for use as a young digital avatar of the user; the user selecting a virtual reality environment and/or activity scenario; generating a young digital avatar within virtual reality environment and/or activity scenario; displaying the young digital avatar within virtual reality environment and/or activity scenario to user using first-person perspective; and synchronizing the young digital avatar's movements with user's movements.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a youth simulator system according to various embodiments described herein.

FIG. 2 illustrates a block diagram showing an example of a server which may be used by the system as described in various embodiments herein.

FIG. 3 shows a block diagram illustrating an example of a computing device which may be used by the system as described in various embodiments herein.

FIG. 4 depicts a block diagram illustrating some modules of a youth simulator system which may function as software rules engines according to various embodiments described herein.

FIG. 5 illustrates a block diagram of an example of a youth simulator method according to various embodiments described herein.

FIG. 6 shows a block diagram of another example of a youth simulator method according to various embodiments described herein.

FIG. 7 depicts a schematic diagram of a user using a youth simulator system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computing device” refers to a machine, apparatus, or device, such as a computer, that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer based on instructions received by computer software.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new system and method that may use virtual reality to transform a user's perception and behavior via youth simulation are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

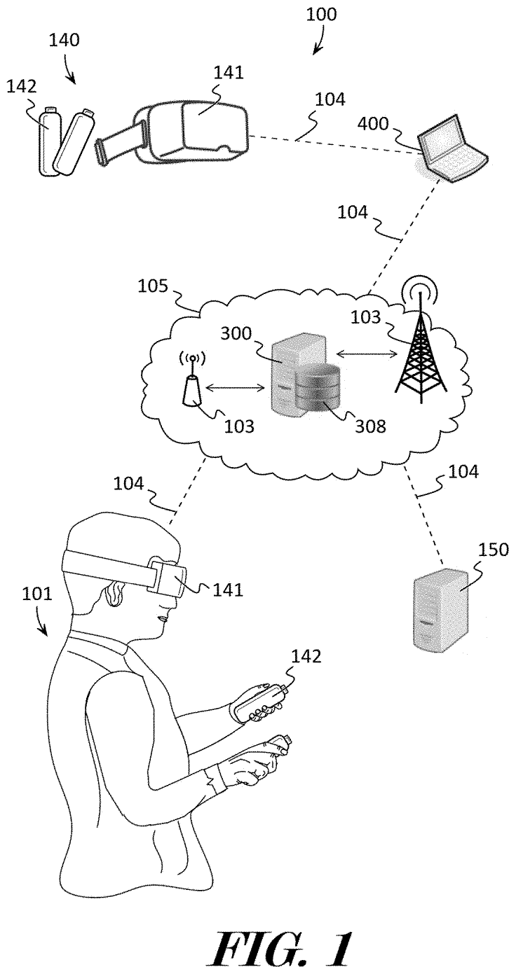

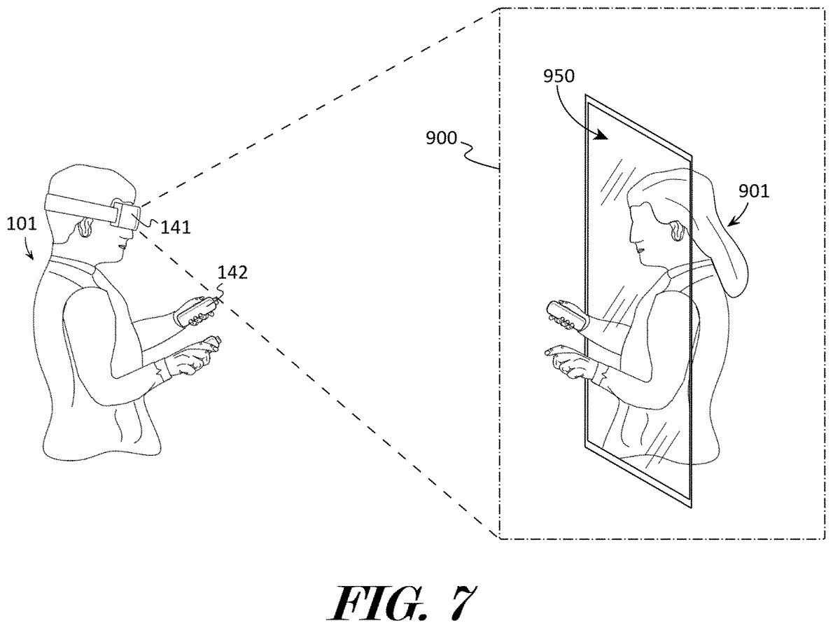

The present invention will now be described by example and through referencing the appended figures representing preferred and alternative embodiments. As perhaps best shown by FIG. 1, an illustrative example of some of the physical components which may comprise a youth simulator system (“the system”) 100 according to some embodiments is presented. Also referring to FIG. 7, the system 100 is configured to generate a young digital avatar 901 of a user 101 and to display the young digital avatar 901 as the user 101 in a virtual reality environment 900 to provide the user 101 with a virtual embodiment of themselves by substitution of user's face and/or body with a younger appearing virtual face and/or body of themselves which may be achieved through first-person viewpoint and synchronous visuomotor feedback. In this manner, the system 100 may be configured to provide immersive virtual reality which allows users 101 to experience the same or similar sensations of ownership over the younger appearing virtual face and/or body of their young digital avatar 901 inside an immersive virtual reality environment 900 as they do over their actual physical body.

In some embodiments, the system 100 may comprise a virtual reality interface 140 which may be worn by a user 101 and which may be configured to display a virtual reality environment 900 and a young digital avatar 901 which has a younger appearing virtual face and/or body of the user 101 to the user 101 via a display interface 141 of the virtual reality interface 140. Additionally, the virtual reality interface 140 may comprise a controller interface 142 which may be configured to receive input from the user 101 allow the user 101 to control the actions and movements of the young digital avatar 901 that has younger appearing virtual face and/or body of the user 101 in the virtual reality environment 900. The system 100 may include a computing device 150 which may be configured to create or generate one or more virtual reality environments 900 which may be displayed to a user 101 through a display interface 141 while allowing the user 101 to interact with the virtual reality environment 900 via a controller interface 142. Additionally, the computing device 150 may create or generate the young digital avatar 901 which has a younger appearing virtual face and/or body of the user 101 in the virtual reality environment 900 and any interactions of the young digital avatar 901 with the virtual reality environment 900.

In some embodiments, data and information of the system 100 may be transferred between one or more access points 103, virtual reality interfaces 140, client devices 400, servers 300, and other computing devices 150 over a data network 105. One or more data stores 308, 408, may contain one or more databases, such as a system database 120. Optionally, one or more computing devices 150 may send data to and receive data from the data network 105 through a network connection 104 with an access point 103. The data may comprise any data which may be used to create or display a virtual reality environment 900 which may be displayed to a user 101 through the virtual reality interface 140 while allowing the user 101 to interact with the virtual reality environment 900, to create or display a young digital avatar 901 having a younger appearing virtual face and/or body to the user 101 in the virtual reality environment 900, and/or any other data which may be used by one or more elements of the system 100.

A computing device 150 may be an electronic device and may comprise a client device 400, server 300, virtual reality interface 140, etc. In this example, the system 100 comprises at least one computing device 150 that may be a virtual reality interface 140 configured to be operated by one or more users 101. Computing devices 150 can be mobile client devices 400, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one virtual reality interface 140, client device 400, and/or server 300 programmed to perform one or more of the steps described herein. In some embodiments, more than one computing device 150 (virtual reality interfaces 140, client devices 400, servers 300, etc.) may be used, with each being programmed to carry out one or more steps of a method or process described herein.

In some embodiments, a computing device 150 may create a virtual reality environment 900 which may be displayed to the user 101 through a virtual reality interface 140. In preferred embodiments, a virtual reality interface 140 may comprise a display interface 141 which may be configured as a virtual reality headset (so that the display interface 141 is worn over a portion of the face of the user 101) which may be in communication with a computing device 150 and which may be used by one or more users 101 to view and/or interact (via their young digital avatar 901) with a virtual reality environment 900 generated or otherwise provided by the computing device 150. In some embodiments, a display interface 141 configured as a virtual reality headset may comprise a stereoscopic head-mounted display (providing separate images for each eye), stereo sound, and/or head motion tracking sensors (which may include gyroscopes, accelerometers, structured light systems, etc.). In further embodiments, a display interface 141 may be configured as a dome, a cave automatic virtual environment (CAVE) which is an immersive virtual reality environment where projectors are directed to between three and six of the walls of a room-sized cube, a 180-degrees display, or any other immersive display which may occupy all or a majority of a user's field of vision while using the display interface 141. Optionally, a display interface 141 may also have eye tracking sensors, motion sensors, and/or gaming controllers. For example, a display interface 141 may comprise a virtual reality headset which may have sensors for detecting the head movements of the user 101 which may be used to change the user's view of the virtual reality environment 900.

In some embodiments, a virtual reality interface 140 may include one or more controller interfaces 142 which may be in communication with a computing device 150 and which may be used by one or more users 101 to provide input to the computing device 150 which may be used to allow their young digital avatar 901 to interact with a virtual reality environment 900 generated or otherwise provided by the computing device 150. In some embodiments, a controller interface 142 may comprise a device used with games or entertainment systems to provide input to a video game, typically to control an object or character in the game. Example controller interfaces 142 include keyboards, mice, gamepads, joysticks, etc. Additionally, controller interfaces 142 may include special purpose devices, such as steering wheels for driving games, light guns for shooting games, fishing rods and reels for sporting games, and the like.

In some embodiments, a virtual reality interface 140 and a computing device 150 may be integrated or otherwise configured as a single unit or device. For example, a virtual reality interface 140 and a computing device 150 integrated together may comprise an Oculus Quest®, the Rift S®, or the HTC Vive®. In preferred embodiments, an integrated virtual reality interface 140 and computing device 150 may comprise any head-mounted display interfaces 141 with one or more controllers or controller interfaces 142 that represent the user's 101 hands so as to achieve full body transfer illusion in the virtual embodiment experience so that when the user 101 moves the controllers in the real world, the actions of the young digital avatar 901 are synchronized with the movements of the user 101 (e.g., when the user 101 moves their hands and controllers in the real world, the young digital avatar 901 moves their hands in the virtual reality environment 900 or world).

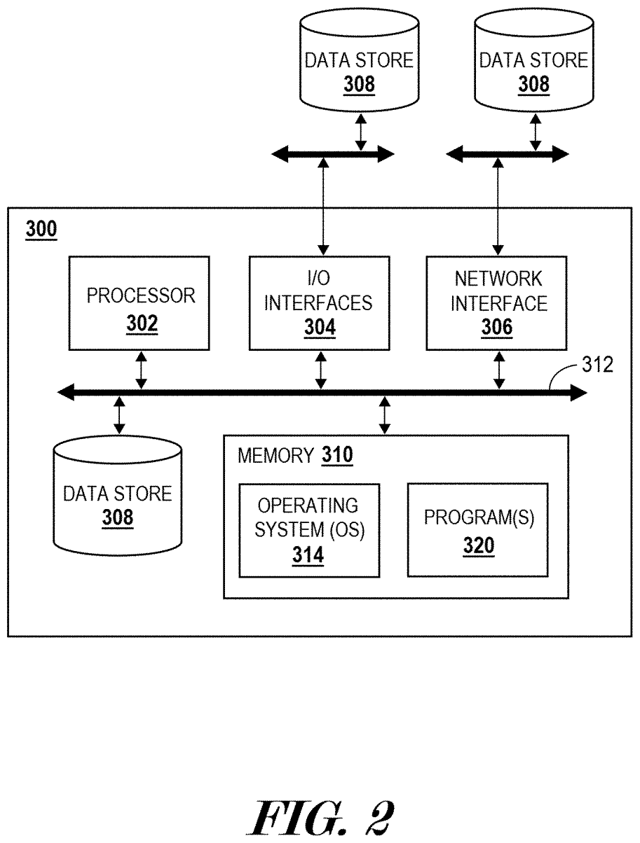

Referring now to FIG. 2, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network.

A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server. Preferably, the system 100 may comprise a system database 330 which may be stored in one or more data stores 308.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

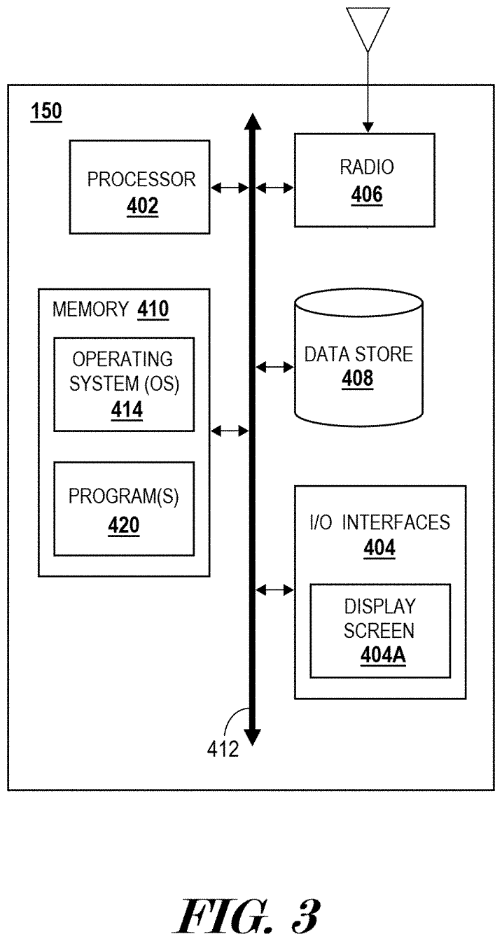

Referring to FIG. 3, in an exemplary embodiment, a block diagram illustrates a computing device 150, such as a virtual reality interface 140 or a client device 400, which one or more users 101 may interact with and of which one or more may be used in the system 100 or the like. A computing device 150 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the computing device 150 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the computing device 150, a semiconductor-based microprocessor (in the form of a microchip or chip set), or generally any device for executing software instructions. When the computing device 150 is in operation, the processor 402 is configured to execute software stored within the memory 410, to communicate data to and from the memory 410, and to generally control operations of the computing device 150 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device 404A, such as a liquid crystal display (LCD), light emitting diode (LED) display, touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the computing device 150. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); Z-Wave wireless communications protocol used primarily for home automation; IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to exchange information with the system 100.

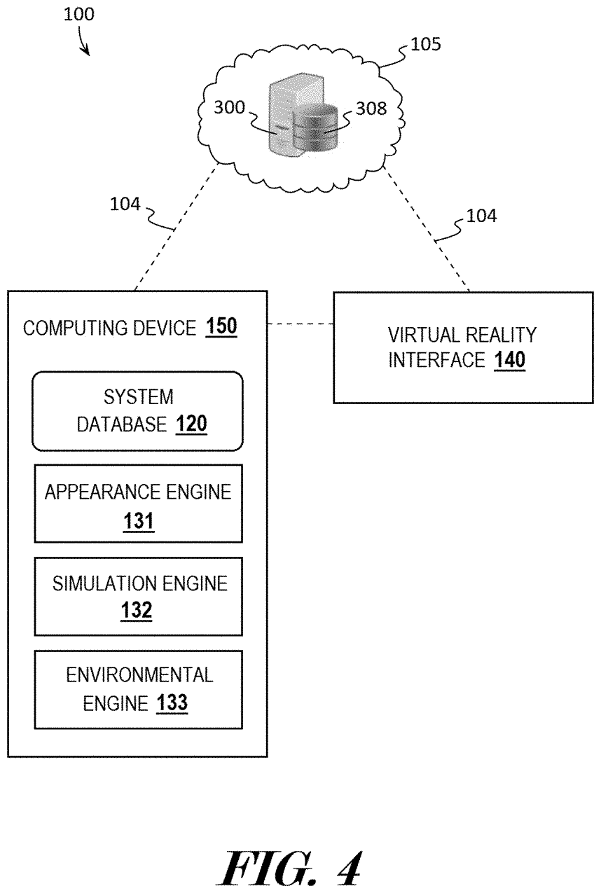

FIG. 4 depicts a block diagram showing some software rules engines which may be found in a system 100 and which may optionally be configured to run on one or more computing devices 150 of the system 100, such as a virtual reality interface 140, server 300, and/or a client device 400 according to various embodiments described herein. In some embodiments, one or more computing devices 150 may be configured to run one or more software rules engines or programs such as an appearance engine 131, a simulation engine 132, and/or an environmental engine 133. In this embodiment, the engines 131, 132, 133, are configured to run on at least one computing device 150, while in other embodiments, two or more computing devices 150 may run one or more of the engines 131, 132, 133, with data being exchanged between the one or more computing devices 150 and engines 131, 132, 133. The system 100 may further comprise one or more system databases 120 which may be stored in one or more data stores 308, 408, and which the engines 131, 132, 133, may be in electronic communication with. The engines 131, 132, 133, may read, write, or otherwise access data in the system database 120. Additionally, the engines 131, 132, 133, may send and receive data to and from one or virtual reality interfaces 140 which may be in wired and/or wireless electronic communication with computing device(s) 150 running the engines 131, 132, 133, through a network 105. It should be understood that the functions attributed to the engines 131, 132, 133, described herein are exemplary in nature, and that in alternative embodiments, any function attributed to any engine 131, 132, 133, may be performed by one or more other engines 131, 132, 133, or any other suitable processor logic.

The system 100 may comprise one or more system databases 120 which may be stored on one or more data stores 308, 408, accessible to the engines 131, 132, 133. In some embodiments, a system database 120 may comprise data and information on one or more users 101, such as one or more digital photographs of the face and optionally the body of a user 101. Preferably the digital photographs may depict the user 101 with a youthful appearance, such as by the photographs being taken at an earlier time when the user 101 felt and/or looked younger than they are currently. In further embodiments, a system database 120 may comprise data which may include a youthful digital 3D model for the user's 101 face and/or a youthful digital 3D model for the user's 101 body which may be used to generate a young digital avatar 901 that may represent the user 101 during virtual reality sessions in the system 100. In further embodiments, a system database 120 may comprise data which may include a digital 3D model for various virtual reality environments and activity scenarios which may be used to generate one or more virtual reality environments 900 that a user 101 may interact with during virtual reality sessions provided by the system 100.

In some embodiments, the system 100 may comprise an appearance engine 131 which may function as appearance logic and which may be run by a computing device 150. In further embodiments, the system 100 may comprise an appearance engine 131 by being in communication with a third-party software application which may function as an appearance engine 131. Generally, an appearance engine 131 may be configured to generate a (preferably youthful) digital 3D model for the user's 101 face and/or a (preferably youthful) digital 3D model for the user's 101 body which may be used to generate a young digital avatar 901 that may represent the user 101 during virtual reality sessions in the system 100. The digital 3D model for the user's 101 face and/or body may be used to form the young digital avatar 901 of the user 101 in a virtual reality environment 900 to provide the user 101 with a virtual embodiment of themselves by substitution of user's face and/or body with a younger appearing virtual face and/or body of themselves in the virtual environment reality environment 900.

Example appearance engines 131 may comprise software, such as Loom.ai SDK available at https://loomai.com, Avatar Maker asset available on Unity Asset Store on the FBX SDK under Autodesk, a neural network, such as which may be used to perform 3D Face Reconstruction from a Single Image via Direct Volumetric CNN Regression, Blender available at www.blender.org, or any other suitable processing logic. For example, an appearance engine 131 may fetch a youthful digital 3D model for the user's 101 face from Avatar SDK servers and may assemble the young digital avatar 901 by attaching the face model to EQLab's morphable and animatable body models which are stored on EQHub's servers.

In preferred embodiments, an appearance engine 131 may be configured to use or combine one or more digital photographs depicting the face of the user 101 at an earlier time when the user 101 felt and/or looked younger into/onto a digital 3D model for the user's 101 face that may be used to form the young digital avatar of the user 101. In this manner, the youthful digital 3D model of the face of the user 101 may be generated using a photograph comprising the user's face at a point in time when the user was younger than they currently are

In further preferred embodiments, an appearance engine 131 may be configured to use or combine one or more digital photographs depicting the body of the user 101 at an earlier time when the user 101 felt and/or looked younger into/onto a youthful digital 3D model for the user's 101 body that may be used to form the young digital avatar of the user 101. In this manner, the youthful digital 3D model of the body of the user 101 may be generated using a photograph comprising the user's 101 body at a point in time when the user 101 was younger than they currently are.

In some embodiments, an appearance engine 131 may generate and export a 3D model for the user's younger appearing face that may be generated using a stock or standard youthful digital 3D model of a face of a youthful looking real-life or computer-generated individual that may be used for the young digital avatar of the user 101, and then the appearance engine 131 may plug the 3D face model into/onto a youthful appearing body modeled in a 3D modeling software program. In this manner, the young digital avatar 901 generated by the appearance engine 131 may comprise a face that resembles the user's 101 face at a point in time when the user 101 appeared younger than they currently are. Preferably, the stock or standard digital 3D face model may have one or more similar appearance attributes to the user 101, such as the same hair color, eye color, skin color, face shape, etc.

In some embodiments, an appearance engine 131 may generate and export a 3D model for the user's younger appearing body that may be generated using a stock or standard youthful digital 3D model of a body of a youthful looking real-life or computer-generated individual that may be used for the young digital avatar of the user 101, and then the appearance engine 131 may plug a 3D face model into/onto the youthful appearing body modeled in a 3D modeling software program. In this manner, the young digital avatar 901 generated by the appearance engine 131 may comprise a body that resembles the user's 101 body at a point in time when the user 101 appeared younger than they currently are. Preferably, the stock or standard digital 3D body model may have one or more similar appearance attributes to the user 101, such as the same body shape, skin color, clothing style, etc.

In some embodiments, the system 100 may allow the user 101 to customize one or more elements of a young digital avatar 901 that may be used to represent the user 101 in a virtual reality environment 900, such as face shape, hair color, hair shape, eye color, skin color, body shape, height, weight, clothing style, etc. In this manner, the system 100 may allow the user 101 to customize the young digital avatar 901 so that the face, body, and/or other elements of the young digital avatar 901 may resemble the face, body, and/or other elements of the user 101 when the user 101 appeared younger than the user 101 currently is. For example, the appearance engine 131 may enable the user 101 to customize the face or head of their young digital avatar 901 (optionally generated using a photograph of the user 101 or generated from a stock model) by allowing the user 101 to select between a number of hairstyle, hair color, eye color, and skin color combinations. As another example, the appearance engine 131 may enable the user 101 to customize the body of their young digital avatar 901 (optionally generated using a photograph of the user 101 or generated from a stock model) by allowing the user 101 to select between a number of gender, muscle, weight, body proportion, outfit type, upper outfit color, and lower outfit color combinations.

The system 100 may comprise a simulation engine 132 which may function as simulation logic and which may be run by a computing device 150. In some embodiments, a simulation engine 132 may receive data describing a (preferably youthful) digital 3D model for the user's 101 face and/or body that may be used to form the young digital avatar 901 of the user 101 and use that data to generate the animations of actions and interactions of the young digital avatar 901 in and with virtual reality environments 900 and activity scenarios provided by an environmental engine 133. In further embodiments, a simulation engine 132 may map the physical movements of the user 101, using data recorded by a controller interface 142 of a virtual reality interface 140, onto a young digital avatar 901 of the user 101 so that the movements of the young digital avatar 901 synchronize or match the actual physical movements of the user 101. In further embodiments, the simulation engine 132 may be configured to display, via first-person perspective, the young digital avatar 901 and their actions in the virtual reality environment 900 to the user 101 via a display interface 141 of a virtual reality interface 140.

The system 100 may comprise an environmental engine 133 which may function as environmental logic and which may be run by a computing device 150. Generally, an environmental engine 133 may use or generate digital 3D models for various virtual reality environments 900 and activity scenarios that a user 101 may interact with during virtual reality sessions in the system 100 that are designed to reinforce the simulation of youth to the user 101. In some embodiments, an environmental engine 133 may be configured to generate two or more activity scenarios for the young digital avatar 901 to participate in, and the system 100 may provide the user with the ability to select between two or more activity scenarios for their young digital avatar 901 to participate in. Examples of such immersive environments 900 and/or activity scenarios may include: visiting bucket-list destinations; swimming with dolphins; going on a safari together with their friends or family members; planting a flag on the Moon not far from the Apollo lunar landing site, etc.

In some embodiments, an environmental engine 133 may be configured to generate one or more virtual reflective surfaces 950 in a virtual reality environment 900 and/or activity scenario that may be displayed to the user 101. Generally, a virtual reflective surface 950 may comprise a reflective or mirror like surface in a virtual reality environment 900 which a user 101 may position their young digital avatar 901 proximate to so that the user 101 may view their young digital avatar 901 in reflection. In preferred embodiments, an environmental engine 133 may be configured to generate a virtual reflective surface 950 in a virtual reality environment 900, and the face and/or body of the young digital avatar 901 may be displayed to the user 101 as a reflection on the virtual reflective surface 950.

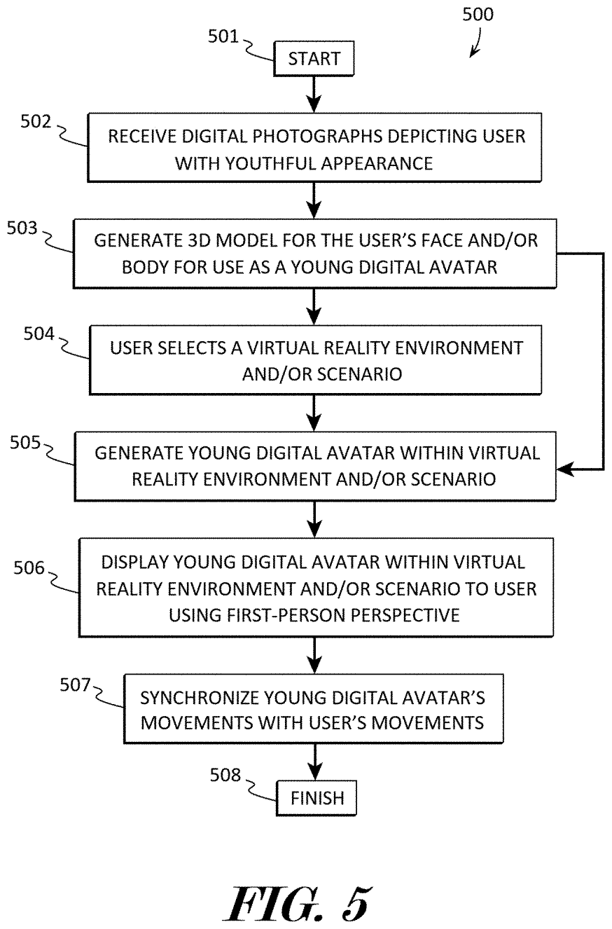

FIG. 5 illustrates a block diagram of an example of a youth simulator method (“the method”) 500 according to various embodiments described herein. The method 500 may be used to generate a young digital avatar 901 of a user 101 and to display the young digital avatar 901 as the user 101 in a virtual reality environment 900 to provide the user 101 with a virtual embodiment of themselves by substitution of user's physical body with a younger appearing virtual face and/or body of themselves which may be achieved through first-person viewpoint and synchronous visuomotor feedback. In this manner, the method 500 may be configured to provide immersive virtual reality which allows users 101 to experience the same or similar sensations of ownership over their younger appearing virtual body 901 inside an immersive virtual reality environment 900 as they do over their actual physical body. One or more steps of the method may be performed by an appearance engine 131, a simulation engine 132, and/or an environmental engine 133.

Generally, the method 500 may be used to provide virtual reality (VR) experiences which will enable users 101, such as older adults, to virtually embody computer-generated avatars of their young and healthy selves and engage in a series of stimulating interactive immersive activities in an effort to improve their mental and behavioral health. In some embodiments, the method 500 may be used to treat or provide symptomatic relief for users 101 suffering from ailments, such as Alzheimer's Disease, dementia, pain, memory loss disorders, etc. This may allow the system 100 and method 500 to ameliorate older adults' performance on a variety of desired and measurable outcomes: to improve mood, behavioral health and enhance psychological and social well-being.

In some embodiments, the method 500 may be used with different treatment protocols, such as repeated exposure, one time only, etc. In further embodiments, the method 500 may be used for treatment in different phases of disease, such as prevention, treatment, rehabilitation, etc. In further embodiments, the method 500 may be used in different settings, such as in hospital, clinic, senior care center, long term care facility, etc. In further embodiments, the method 500 may be used in different treatment methodologies, such as part of a more comprehensive treatment or standalone treatment.

In some embodiments, the method 500 may start 501 and one or more digital photographs or images of a user 101 depicting the user 101 as being younger looking in appearance may be received by a computing device 150, such as which may be running an appearance engine 131 and/or which may have access to a system database 120 in step 502. Preferably, the one or more digital photographs or images, which may include videos and other digital image files, may be received by an appearance engine 131 or they may be uploaded to a system database 120 which may be accessible by an appearance engine 131. It should be understood that the method 500 and system 100 may be used to allow one user 101 or two or more users 101, such as patients, family members, caregivers, other older adults, etc., the ability to interact and share in one or more virtual reality environments 900 and/or activity scenarios using their own digital avatar 901 (which may be a young digital avatar 901).

Digital photographs of a user 101 depicting the user 101 as being younger looking in appearance may comprise photographs, videos, etc., which may have been taken before the time that the user 101 is to participate in the method 500. In some embodiments, the digital photographs may be taken between one day and 90 years prior (depending on the age of the user 101) to the time that the user 101 is to participate in the method 500. For example, for an eighty-five-year-old user 101, one or more digital photographs, videos, etc., of the user 101 that were taken while the user 101 was in their twenties or thirties may be received in step 502.

In step 503, a 3D model for the user's 101 face and/or all or portions of their body for use as a young digital avatar 901 of the user 101 may be generated. In some embodiments, an appearance engine 132 may use or combine one or more digital photographs from step 502 depicting the user 101 at an earlier time when the user 101 felt and/or looked younger into a youthful digital 3D model for the user's 101 face and/or body that may be used to form the young digital avatar 901 of the user 101. Continuing the above example, the appearance engine 132 may use or combine the one or more digital photographs from step 502 into a youthful digital 3D model for the user's 101 face and/or body that may be used to form a twenty or thirty-year-old looking digital avatar of the user 101. In preferred embodiments, an appearance engine 132 may generate and export a 3D model for the user's younger appearing face, and then plug the 3D face model into a body modeled in a 3D modeling software program. In further embodiments, an appearance engine 132 may generate and export a stock 3D model to generate a young digital avatar 901 which may resemble the user's face and/or body at a point in time when the user 101 appeared younger than they currently are.

In optional step 504, the user 101, or an individual acting on the user's behalf, may select a virtual reality environment 900 and/or activity scenario(s) that may be made available by an environmental engine 133 which they desire to partake in while using the system 100. In preferred embodiments, an environmental engine 133 may provide the user 101 the ability to choose between various virtual reality environments 900 and activity scenarios that a user 101 may interact with using their young digital avatar 901 during virtual reality sessions in the system 100 that are designed to reinforce the simulation of youth to the user 101. Examples of such immersive virtual reality environments 900 and/or activity scenarios may include: visiting bucket-list destinations; swimming with dolphins; going on a safari together with their friends or family members; planting a flag on the Moon not far from the Apollo lunar landing site, etc. In some embodiments, the various virtual reality environments 900 and/or activity scenario(s) may be displayed to the user 101 via a display interface 141 and selected from using a controller interface 142 of a virtual reality interface 140, an I/O interface 400 of a computing device 150, or any other input method.

In step 505, a young digital avatar 901 within the virtual reality environment 900 and/or activity scenario selected in step 504 may be generated via a simulation engine 132 and an environmental engine 133. In some embodiments, a simulation engine 132 may receive data describing a youthful digital 3D model for the user's 101 face and/or body that may be used to form the young digital avatar 901 of the user 101, while an environmental engine 133 may use or generate digital 3D models for a selected virtual reality environment 900 and activity scenario(s) that a user 101 may interact with.

In step 506, the young digital avatar 901 within virtual reality environment 900 and/or activity scenario may be displayed to the user 101 using first-person perspective. In preferred embodiments, the young digital avatar 901 within virtual reality environment 900 and/or activity scenario may be displayed to the user 101 using first-person perspective via a headset type of display interface 141 of a virtual reality interface 140. This may include displaying to the user 101 virtual engaging interactions with the computer-generated environment, with virtual agents inside of the immersive environment as well as with other human participant users 101, such as family members, caregivers, other older adults, etc., of the multi-user and networked VR experiences. In further preferred embodiments, the virtual reality environment 900 and/or activity scenario may include one or more virtual reflective surfaces 950, which may comprise reflective or mirror like surfaces in a virtual reality environment 900 which a user 101 may position their young digital avatar 901 proximate to so that the user 101 may view their young digital avatar 901 in reflection. For example, the opening scene of every experience may involve a mirror type of virtual reflective surface 950 in which the user 101 can view and contemplate their new younger virtual selves (their young digital avatar 901).

In step 507, the young digital avatar's 901 movements in the virtual reality environment 900 may be synchronized with the user's 101 physical movements. In some embodiments, data describing the user's 101 movements may be recorded by a display interface 141 and/or controller interface 142 of a virtual reality interface 140. This data may be used by a simulation engine 132 to map the movements of the user 101, using data recorded by a virtual reality interface 140, onto a young digital avatar 901 of the user 101 so that the movements of the young digital avatar 901 of the user 101 may be synchronized to match actual physical movements of the user 101. By synchronizing the young digital avatar's 901 movements in the virtual reality environment 900 and displaying the young digital avatar 901 to the user 101 using first-person perspective, the method 500 may provide or elicit a body transfer illusion for its older users 101 from their bodies to the virtual bodies of their younger avatars 901.

After step 507, the method 500 may finish 508.

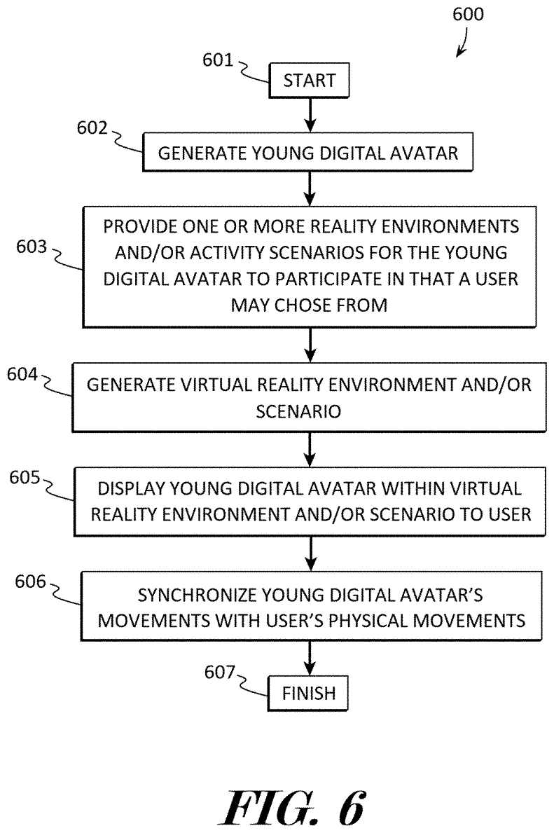

FIG. 6 illustrates a block diagram of another example of a youth simulator method (“the method”) 600 according to various embodiments described herein. The method 600 may be used to generate a young digital avatar 901 of a user 101 and to display the young digital avatar 901 as the user 101 in a virtual reality environment 900 to provide the user 101 with a virtual embodiment of themselves by substitution of user's physical body with a younger appearing virtual face and/or body of themselves which may be achieved through first-person viewpoint and synchronous visuomotor feedback. In this manner, the method 600 may be configured to provide immersive virtual reality which allows users 101 to experience the same or similar sensations of ownership over their younger appearing virtual body 901 inside an immersive virtual reality environment 900 as they do over their actual physical body. One or more steps of the method may be performed by an appearance engine 131, a simulation engine 132, and/or an environmental engine 133.

Generally, the method 600 may be used to provide virtual reality (VR) experiences which will enable users 101, such as older adults, to virtually embody computer-generated avatars of their young and healthy selves and engage in a series of stimulating interactive immersive activities in an effort to improve their mental and behavioral health. In some embodiments, the method 600 may be used to treat or provide symptomatic relief for users 101 suffering from ailments, such as Alzheimer's Disease, dementia, pain, memory loss disorders, etc. This may allow the system 100 and method 600 to ameliorate older adults' performance on a variety of desired and measurable outcomes: to improve mood, behavioral health and enhance psychological and social well-being.

In some embodiments, the method 600 may be used with different treatment protocols, such as repeated exposure, one time only, etc. In further embodiments, the method 600 may be used for treatment in different phases of disease, such as prevention, treatment, rehabilitation, etc. In further embodiments, the method 600 may be used in different settings, such as in hospital, clinic, senior care center, long term care facility, etc. In further embodiments, the method 600 may be used in different treatment methodologies, such as part of a more comprehensive treatment or standalone treatment.

In some embodiments, the method 600 may start 601 and a young digital avatar 901 may be generated in step 602. In some embodiments of step 602, one or more digital photographs or images of a user 101 depicting the user 101 as being younger looking in appearance may be received by a computing device 150, such as which may be running an appearance engine 131 and/or which may have access to a system database 120. Preferably, the one or more digital photographs or images, which may include videos and other digital image files, may be received by an appearance engine 131 or they may be uploaded to a system database 120 which may be accessible by an appearance engine 131. It should be understood that the method 600 and system 100 may be used to allow one user 101 or two or more users 101, such as patients, family members, caregivers, other older adults, etc., the ability to interact and share in one or more virtual reality environments 900 and/or activity scenarios using their own digital avatar 901 (which may be a young digital avatar 901).

Digital photographs of a user 101 depicting the user 101 as being younger looking in appearance may comprise photographs, videos, etc., which may have been taken before the time that the user 101 is to participate in the method 600. In some embodiments, the digital photographs may be taken between one day and 90 years prior (depending on the age of the user 101) to the time that the user 101 is to participate in the method 600. For example, for an eighty-five-year-old user 101, one or more digital photographs, videos, etc., of the user 101 that were taken while the user 101 was in their twenties or thirties may be received in step 602.

In further embodiments of step 602, a 3D model for the user's 101 face and/or all or portions of their body for use as a young digital avatar 901 of the user 101 may be generated. In some embodiments, an appearance engine 132 may use or combine one or more digital photographs from step 502 depicting the user 101 at an earlier time when the user 101 felt and/or looked younger into a youthful digital 3D model for the user's 101 face and/or body that may be used to form the young digital avatar 901 of the user 101. Continuing the above example, the appearance engine 132 may use or combine the one or more digital photographs into a youthful digital 3D model for the user's 101 face and/or body that may be used to form a twenty or thirty-year-old looking digital avatar of the user 101. In preferred embodiments, an appearance engine 132 may generate and export a 3D model for the user's younger appearing face, and then plug the 3D face model into a body modeled in a 3D modeling software program. In further embodiments, an appearance engine 132 may generate and export a stock 3D model to generate a young digital avatar 901 which may resemble the user's face and/or body at a point in time when the user 101 appeared younger than they currently are.

In step 603, one or more virtual reality environments 900 and/or activity scenarios for the young digital avatar 901 to participate in may be provided to the user 101 that the user may choose to participate in. Preferably, an environmental engine 133 may display two or more activity scenarios for the young digital avatar 901 to participate in to the user 101 by displaying then as choices via display interface 141 and the user 101 may select the desired virtual reality environment 900 and/or activity scenario via a controller interface 142. In preferred embodiments, an environmental engine 133 may provide the user 101 the ability to choose between various virtual reality environments 900 and activity scenarios that a user 101 may interact with using their young digital avatar 901 during virtual reality sessions in the system 100 that are designed to reinforce the simulation of youth to the user 101. Examples of such immersive virtual reality environments 900 and/or activity scenarios may include: visiting bucket-list destinations; swimming with dolphins; going on a safari together with their friends or family members; planting a flag on the Moon not far from the Apollo lunar landing site, etc. In some embodiments, the various virtual reality environments 900 and/or activity scenario(s) may be displayed to the user 101 via a display interface 141 and selected from using a controller interface 142 of a virtual reality interface 140, an I/O interface 400 of a computing device 150, or any other input method.

In step 604, a virtual reality environment 900 and/or scenario may be generated by the system 100. In some embodiments, an environmental engine 133 may use or generate digital 3D models for a selected virtual reality environment 900 and activity scenario(s) that a user 101 may interact with.

In step 605, the young digital avatar 901 may be displayed within virtual reality environment 900 and/or scenario to user 101 using first-person perspective via a display interface 141. In some embodiments, the young digital avatar 901 within the virtual reality environment 900 and/or activity scenario selected in step 603 may be generated via a simulation engine 132 and an environmental engine 133. In some embodiments, a simulation engine 132 may receive data describing a youthful digital 3D model for the user's 101 face and/or body that may be used to form the young digital avatar 901 of the user 101, while an environmental engine 133 may use or generate digital 3D models for a selected virtual reality environment 900 and activity scenario(s) that a user 101 may interact with. This may include displaying to the user 101 virtual engaging interactions with the computer-generated environment, with virtual agents inside of the immersive environment as well as with other human participant users 101, such as family members, caregivers, other older adults, etc., of the multi-user and networked VR experiences. In further preferred embodiments, the virtual reality environment 900 and/or activity scenario may include one or more virtual reflective surfaces 950, which may comprise reflective or mirror like surfaces in a virtual reality environment 900 which a user 101 may position their young digital avatar 901 proximate to so that the user 101 may view their young digital avatar 901 in reflection. For example, the opening scene of every experience may involve a mirror type of virtual reflective surface 950 in which the user 101 can view and contemplate their new younger virtual selves (their young digital avatar 901).

In step 606, the young digital avatar's 901 movements within the within the virtual reality environment 900 may be synchronize with the user's 101 physical movements. In some embodiments, data describing the user's 101 physical movements may be recorded by a display interface 141 and/or controller interface 142 of a virtual reality interface 140. This data may be used by a simulation engine 132 to map the movements of the user 101, using data recorded by a virtual reality interface 140, onto a young digital avatar 901 of the user 101 so that the movements of the young digital avatar 901 of the user 101 may be synchronized to match actual physical movements of the user 101. By synchronizing the young digital avatar's 901 movements in the virtual reality environment 900 and displaying the young digital avatar 901 to the user 101 using first-person perspective, the method 600 may provide or elicit a body transfer illusion for its older users 101 from their bodies to the virtual bodies of their younger avatars 901.

After step 606, the method 600 may finish 607.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or Wi-Fi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A youth simulator system for use by a user having a face and a body, the system comprising:
a virtual reality interface having a display interface and a controller interface, the virtual reality interface configured to record data describing the physical movements of the user as the user operates the virtual reality interface;
an appearance engine configured to generate a youthful digital 3D model of the user, wherein the appearance engine is configured to generate a young digital avatar of the user, having a face and a body, from the youthful digital 3D model of the user;
an environmental engine configured to generate an environmental digital 3D model of a virtual reality environment; and
a simulation engine, wherein the simulation engine is configured to generate actions of the young digital avatar in the virtual reality environment using the data describing the physical movements of the user so that the actions of the young digital avatar are synchronized with the movements of the user, and wherein the simulation engine is configured to display, via first-person perspective, the young digital avatar and their actions in the virtual reality environment to the user via the display interface.

2. The system of claim 1, wherein the youthful digital 3D model is generated using a photograph comprising the user's face at a point in time when the user was younger than they currently are.

3. The system of claim 2, wherein the young digital avatar comprises a face that resembles the user's face at a point in time when the user was younger than they currently are.

4. The system of claim 1, wherein the youthful digital 3D model is generated using a photograph comprising the user's body at a point in time when the user was younger than they currently are.

5. The system of claim 4, wherein the young digital avatar comprises a body that resembles the user's body at a point in time when the user appeared younger than they currently are.

6. The system of claim 1, wherein the young digital avatar comprises a body that resembles a body that appears younger than the user's body currently is.

7. The system of claim 1, wherein the virtual reality environment comprises a virtual reflective surface, and wherein the face of the young digital avatar is displayed to the user as a reflection on the virtual reflective surface.

8. The system of claim 1, wherein the virtual reality environment comprises a virtual reflective surface, and wherein the body of the young digital avatar is displayed to the user as a reflection on the virtual reflective surface.

9. The system of claim 1, wherein the display interface is worn over a portion of the face of the user.

10. The system of claim 1, wherein the user is able to select between two or more activity scenarios for the young digital avatar to participate in.

11. A youth simulator method for use by a user having a face and a body, the method comprising the steps of:
receiving a digital photograph depicting the user at a point in time when the user was younger than they currently are;
generating a youthful digital 3D model of the user;
generating a young digital avatar of the user, having a face and a body, in a virtual reality environment;
displaying to the user, via first-person perspective, the young digital avatar within the virtual reality environment; and
synchronizing movements of the young digital avatar with movements of the user.

12. The method of claim 11, wherein the youthful digital 3D model is generated using a photograph comprising the user's face at a point in time when the user was younger than they currently are.

13. The method of claim 12, wherein the young digital avatar comprises a face that resembles the user's face at a point in time when the user was younger than they currently are.

14. The method of claim 11, wherein the youthful digital 3D model is generated using a photograph comprising the user's body at a point in time when the user was younger than they currently are.

15. The method of claim 14, wherein the young digital avatar comprises a body that resembles the user's body at a point in time when the user appeared younger than they currently are.

16. The method of claim 11, wherein the young digital avatar comprises a body that resembles a body that appears younger than the user's body currently is.

17. The method of claim 11, wherein the virtual reality environment comprises a virtual reflective surface, and wherein the face of the young digital avatar is displayed to the user as a reflection on the virtual reflective surface.

18. The method of claim 11, wherein the virtual reality environment comprises a virtual reflective surface, and wherein the body of the young digital avatar is displayed to the user as a reflection on the virtual reflective surface.

19. The method of claim 11, wherein the young digital avatar in the virtual reality environment is displayed to the user via a display interface that is worn over a portion of the face of the user.

20. The method of claim 11, further comprising the step of allowing the user to select at least one of a virtual reality environment and an activity scenario for the young digital avatar to participate in.
